(19) United States
(12) Patent Application Publication
(10) Pub. No.: US 2026/0297301 A1
(43) Pub. Date: Oct. 1, 2026

(54) POLYSILOXANE FILLER TREATING AGENT AND COMPOSITION PREPARED THEREWITH

(71) Applicants: Dow Global Technologies LLC, Midland, MI (US); Dow Silicones Corporation, Midland, MI (US); Rohm and Haas Company, Collegeville, PA (US)

(72) Inventors: Hai Wang, Royersford, PA (US); Matthew Carter, Bala Cynwyd, PA (US); Hongyun Xu, Midland, MI (US); Dan Zhao, Midland, MI (US); Elena C. Montoto Blanco, Chicago, IL (US); Tzu-Chi Kuo, Midland, MI (US); Eric Joffre, Shepherd, MI (US)

(21) Appl. No.: 18/996,346

(22) PCT Filed: Aug. 4, 2023
(86) PCT No.: PCT/US2023/071640

§ 371 Date: Jan. 17, 2025

Related U.S. Application Data
(60) Provisional application No. 63/396,030, filed on Aug. 8, 2022.

(51) Int. Cl. C08K 13/02; C08K 3/22; C08K 5/5415; C09C 1/40; C09C 3/12

(52) U.S. Cl. CPC C08K 13/02; C08K 3/22; C08K 5/5415; C09C 1/407; C09C 3/12; C08K 2003/2227

(57) ABSTRACT

The present invention relates to a composition comprising: a) a polyorganosiloxane; b) filler particles; and c) a filler treating agent of Formula I: Formula I where R1, R2, m, n, p, and q are as defined herein. The composition is useful as a thermally conductive formulation.

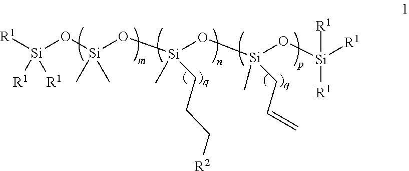

### BACKGROUND OF THE INVENTION

The present invention relates to a polysiloxane-based filler treating agent and its application in thermally conductive formulations.

Increased demand for conductive composite materials is driving the discovery of thermally conductive formulations that provide more uniform and more efficient heat dissipation from integrated circuits, battery packs, microelectronic circuitry, and electric motors. The major components of conventional thermally conductive formulations are a matrix polymer, inorganic filler particles, and a filler treating agent (FTA). The inorganic particles are the least expensive component in a thermally conductive formulation and provide heat dissipation. It is desirable, therefore, to load and uniformly disperse high levels of filler particles into the matrix polymer; uniform dispersion is challenging, however, because the filler particles are generally incompatible with the matrix polymer, resulting in phase separation. FTAs, which have chemical functionalities compatible with both the matrix polymer and the filler particles promote compatibility and improve the dispersability of filler particles with the matrix by associating with the surface of the inorganic particles. Examples of commercially available FTAs are monotrimethoxysilyloxy-terminated polydimethylsiloxanes, represented by the following formula:

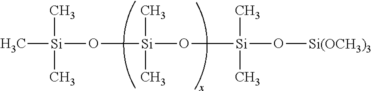

(See U.S. Pat. No. 7,592,383 B2, column 6). Unfortunately, while this class, as well as other structurally similar FTAs are high performing, they are extremely costly because they are prepared by multistep synthetic procedures that require the use of toxic reagents and solvents, and a host of purification steps. It would therefore be an advantage in the art of compatibilizing agents for thermally conductive formulations to discover a relatively low-cost FTA that has acceptable performance properties, including squeeze flow, extrusion rate, and viscosity.

### SUMMARY OF THE INVENTION

The present invention addresses a need in the art by providing a composition comprising:
a) a polyorganosiloxane;
b) filler particles; and
c) a filler treating agent of Formula I:

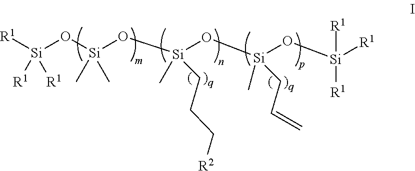

where m is from 5 to 150; n is from 1 to 3; p is from 0 to 3; q is from 0 to 8; each R¹ is independently C₁-C₆-alkyl, vinyl, phenyl, or benzyl; each R¹′ is independently C₁-C₆-alkyl;
R² is:

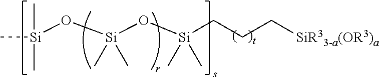

where r is from 0 to 5; s is 0 or 1; t is from 0 to 15; each R³ is independently C₁-C₆-alkyl; a is an integer of 1 to 3; wherein the polyorganosiloxane has degree of polymerization in the range of from 40 to 800.

The composition of the present invention is useful as a thermally conductive formulation.

### DETAILED DESCRIPTION OF THE INVENTION

The present invention is a composition comprising:
a) a polyorganosiloxane;
b) filler particles; and
c) a filler treating agent of Formula I:

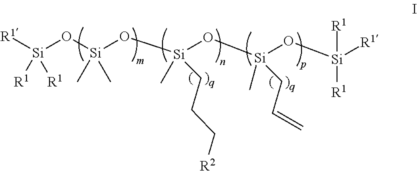

where m is from 5 to 150; n is from 1 to 3; p is from 0 to 3; q is from 0 to 8; each R¹ is independently C₁-C₆-alkyl, vinyl, phenyl, or benzyl; each R¹′ is independently C₁-C₆-alkyl;
R² is:

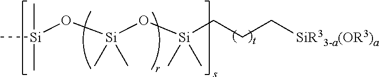

where r is from 0 to 5; s is 0 or 1; t is from 0 to 15; each R³ is independently C₁-C₆-alkyl; a is an integer of 1 to 3; and the dashed line represents the point of attachment to the alkylene group;
wherein the polyorganosiloxane has degree of polymerization in the range of from 40 to 800.

The FTA of Formula I is a random copolymer; that is to say, the structural units with subscripts m, n, and p need not be in the order depicted in Formula I. Preferably m is from 20 or from 50, to preferably 125; preferably, n is from 1 or from 1.5 or from 1.8, to 3 or to 2.5 or to 2.2; p is from 0 to 3 or to 2 or to 1 or to 0.5; q is from 1 or from 2 to 6 or to 4; each R¹ is preferably independently C₁-C₆-alkyl, more preferably methyl or ethyl, and most preferably methyl; R³ is preferably methyl or ethyl, more preferably methyl; a is preferably 2 or 3, more preferably 3.

In one aspect, R² is represented by the following group:

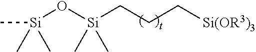

where t is 0 or 1 or 2 or 3.

In another aspect, R² is represented by the following group:

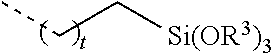

where q+t is in the range of 0 or from 1 or from 3 or from 5, to 20 or to 14 or to 9.

The filler treating agent of the present invention may be prepared by contacting a compound of Formula Ia:

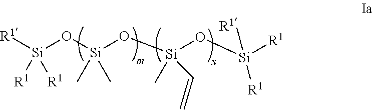

where x is n+p; with a compound of the following formula Ib:

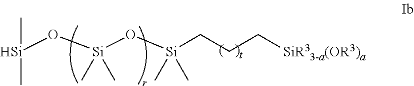

in the presence of platinum catalyst and at advanced temperatures, to form a compound of Formula I, where R² is:

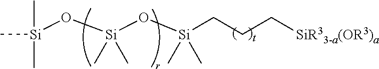

The filler treating agent may also be prepared by contacting a compound of Formula Ic:

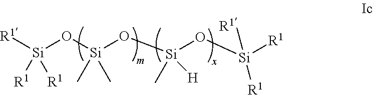

where x is n+p; with a compound of Formula Id:

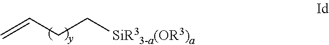

in the presence of platinum catalyst and at advanced temperatures, to form a compound of Formula I, where s is 0 and y is from 0 to 25.

The polyorganosiloxane may be functionalized with, for example, one or more crosslinkable groups, such as terminal vinyl groups. Examples of such functionalized polyorganosiloxanes include monovinyl-di-C₁-C₆-alkyl terminated polysiloxane and bis(vinyl-di-C₁-C₆-alkyl) terminated polysiloxane, more particularly bis(vinyl-dimethyl) terminated polysiloxane, which can be prepared as described in U.S. Pat. No. 4,329,273.

The filler particles are metal, metal oxide, metal hydrate, or ceramic nitride particles such as aluminum, aluminum oxide (alumina), aluminum trihydrate, boron nitride, or zinc oxide particles. The D₅₀ particle size of the filler particles, as determined using a HELOS laser diffraction device, is typically in the range of from 0.5 μm to 100 μm. A multimodal (e.g., bimodal) distribution of first and second filler particles may be used in the formulation to boost filler particle concentration.

The polyorganosiloxane concentration is preferably in the range of from 1.9 or from 5 wt. % to 15 or to 10 wt. % based on the weight of the composition; the FTA concentration is preferably in the range of from 0.1 or from 0.2 or from 0.3 wt. %, to 3 or to 1 or to 0.7 or to 0.5 wt. %, based on the weight of the composition; and the filler loading is preferably in the range of from 70 or from 80 or from 85 or from 90 wt. % to 98 or to 94 wt. %, based on the weight of the composition. The formulated composition of the present invention has been found to have a favorable squeeze flow rate, viscosity, extrusion rate, and thermal conductivity.

### EXAMPLES

### Size Exclusion Chromatography Method

SEC separations were performed on a liquid chromatograph with an Agilent 1260 Infinity II isocratic pump, multicolumn thermostat, integrated degasser, autosampler, and refractive index detector. The system was equipped with two PLgel Mixed A columns (300×7.5 mm i.d., particle size=20 μm) and a guard column (50×7.5 mm i.d.). The column oven and the refractive index detector operated at 40° C. The sample injection volume was 100 μL and separations were performed with THF as the eluent at a flow rate of 1.0 mL/min. The instrument was calibrated with ten narrow-dispersity polystyrene standards from 580-371,000 Da. Data analysis was carried out using the Agilent GPC/SEC software package version A.02.01 (Build 9.34851).

### NMR Spectroscopy Method

NMR spectroscopy was performed using a Bruker Avance III HD 500 spectrometer equipped with a 5-mm Prodigy BBO CryoProbe (Billerica, MA). Proton spectra were acquired with a pulse repetition delay of 10 s. Chemical shifts are reported relative to the residual solvent protons of CDCl3 (δ ¹H, 7.26 ppm).

### Example A—Preparation of Filler Treating Agent

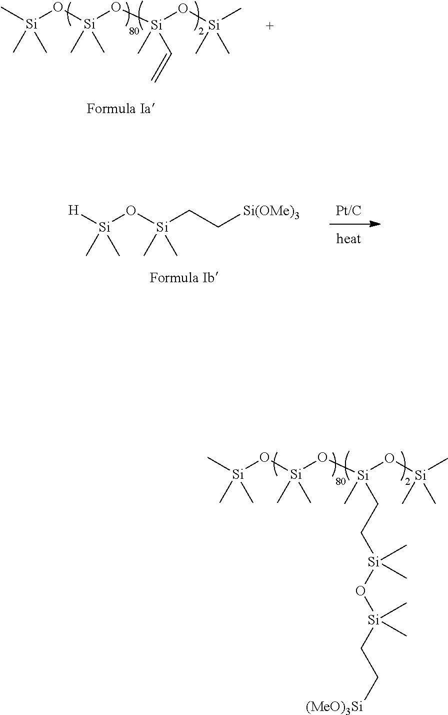

A copolymer of Formula Ia′ and a compound of Formula Ib′ were mixed at room temperature at a 1:1 molar ratio of vinyl to Si—H groups. Karstedt's catalyst (0.1 mol % based on vinyl groups) was added to the mixture and the temperature was elevated to 120° C. After 2 h the mixture was allowed to cool to room temperature, after which time the reaction mixture was diluted with CHCl₃ and filtered through activated charcoal/Celite. Volatile substances in the polymer solution were removed, and the product was characterized by SEC and NMR.

### Example B—Preparation of Filler Treating Agent

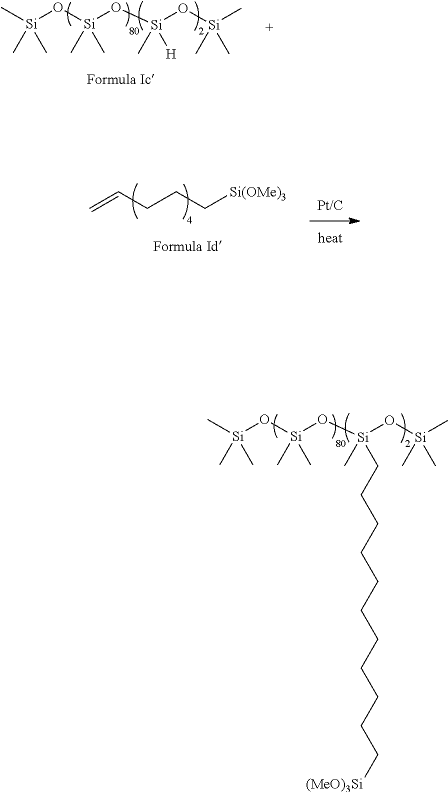

The copolymer of Formula Ic′ and the compound of Formula Id′ were mixed at room temperature at a 1:1 molar ratio of vinyl to Si—H groups and the reaction, workup, and characterizations were carried out as described in Example A.

### Examples C, D, E—Preparation of Filler Treating Agents

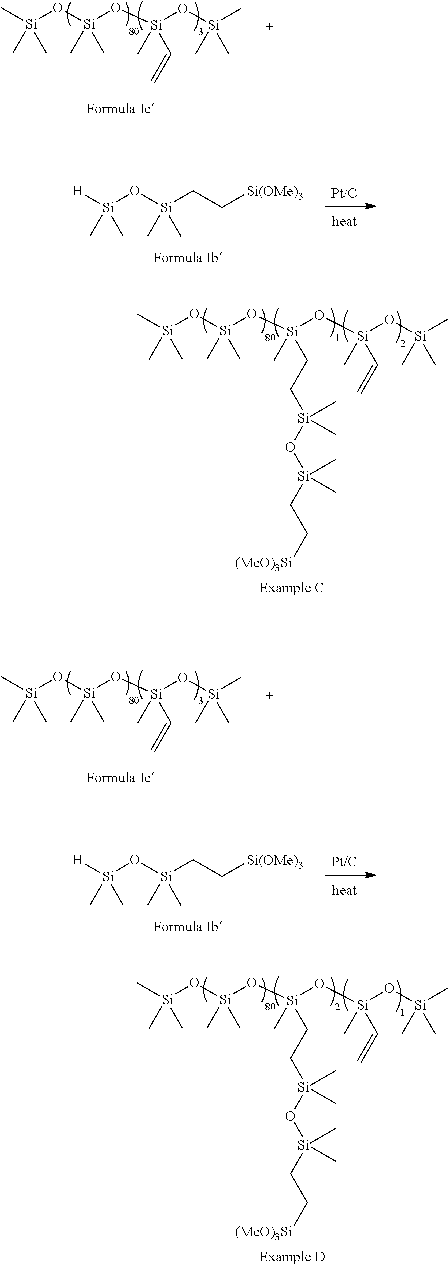

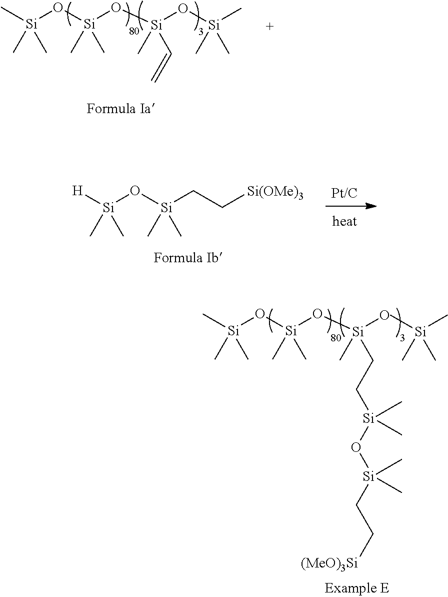

The compound of Formula Ie′ and Formula Ib′ were mixed at room temperature at 3:1, 3:2, and 1:1 mole-to-mole ratios of vinyl to Si—H groups to prepare Examples C, D, and E.

### Examples 1-5 and Comparative Example 1—Preparation of Formulations Containing an FTA

Formulations were prepared by combining the FTA (0.23 g) with DOWSIL™ 2-7287 Vinyl dimethyl terminated polydimethylsiloxane (5.31 g, viscosity=80 cP, A Trademark of The Dow Chemical Company or its Affiliates) and DOWSIL™ CV-119 Vinyl dimethyl terminated polydimethylsiloxane (1.79 g, viscosity=450 cP) in a Max-10 mixer cup and mixing at a speed of 2000 rpm for 30 s. This blend was then combined with SB 36 Alumina Trihydrate (7.07 g, D₅₀=25 μm) in a Max-40 mixer cup and mixed at a speed of 1300 rpm for 30 s. Maxfil MX200 Alumina Trihydrate (35.57 g, D₅₀=45 μm) was added to the formulation and mixed at a speed of 1300 rpm for 30 s. The formulated material was then hand-mixed, then mixed again at 1300 rpm for 30 s, then transferred to a glass jar and heated at 150° C. under vacuum for 1 h. The total filler loading of the material was 85.3 wt. % and 69.7 vol %.

### Measurement of Squeeze Flow

A squeeze-flow test was used to characterize the flowability of the test formulations containing FTA samples as follows: The thermally conductive test formulation (0.6 g) was sandwiched between two glass slides (25×7 5×1.0 mm, obtained from Thermofisher) and separated by two 1-mm shims to control the thickness. The top glass slide was manually pressed down to ensure a uniform spread of the material, and the initial diameter of the material was recorded as D₁. The 1-mm spacers were then removed from the test sample, and a 350-g mass was placed on the top glass and allowed to stand for 1 min. The post-squeeze diameter was recorded as D₂ and the squeeze flow was calculated as ΔR=(D₂−D₁)/2 (mm).

### Measurement of Viscosity at 0.1% Strain

An oscillatory shear strain amplitude sweep was performed on the test formulation samples to characterize the formulation viscosity and the shear thinning behavior. The test formulation samples are loaded onto the Anton Paar High Throughput Rheometer (AP HT Rheometer) using 25-mm parallel plate geometry. Trimming was performed at 1.0-mm gap with the automatic trimming robot. After a 300-s pre-test soaking time, the measurements were taken using the standard procedure of 10 rad/s oscillation frequency, sweeping from 0.01 to 300% strain amplitude with 20 sampling points per decade. Viscosity at 0.1% strain (low shear rate viscosity) was reported.

### Measurement of Extrusion Rate

Extrusion rates were measured by loading the gel formulations into a 30-mL EFD syringe. The syringe was then attached to the EFD dispensing apparatus and material was dispensed at 55 Psi under nitrogen for 5 s. The extrusion rate was recorded as the mass dispensed during the 5-s dispensing period, as determined using an analytical balance.

### Thermal Conductivity Measurements

Thermal conductivity was measured using a Hot Disk transient plane source tool (TPS 2500S) and a Kapton-encased thermal probe. Isotropic bulk measurements were performed on 6 mm diameter vessels.

Table 1 illustrates Squeeze flow (S.F, in mm), Viscosity @ 0.1% strain (Visc., in Pa·s) and Extrusion rate at 55 psi (E.R., in g/5 s) for the thermal gel samples. RMS-759 refers to DOWSIL™ RMS-759 Mono-trimethoxysiloxy-dimethylsiloxane Polymer (A Trademark of The Dow Chemical Company or its Affiliates), which is the FTA used in Comparative Example 1. The thermal conductivity of the all the formulations were measured at 2.3 W/m·K.

TABLE 1
Properties of Thermal Gel Samples

| Ex# | FTA | S.F. | Visc. | E.R. |
|---|---|---|---|---|
| C1 | RMS-759 | 9.6 | 61.9 | 0.46 |
| 1 | Ex. A | 8.3 | 88.0 | 2.3 |
| 2 | Ex. B | 7.8 | 88.5 | 2.4 |
| 3 | Ex. C | 8.6 | 108.8 | 2.0 |
| 4 | Ex. D | 9.4 | 194.8 | 2.9 |
| 5 | Ex. E | 9.5 | 243.1 | 2.3 |

Examples 1-5 formulations exhibited acceptable squeeze flows, viscosities @ 0.1% strain, extrusion rates, and thermal conductivity. Extrusion rates were significantly improved as compared with the commercial formulation (C1). The formulations of the present invention also benefit from the ease of preparation of the FTAs.

1. A composition comprising:
a) a polyorganosiloxane;
b) filler particles; and
c) a filler treating agent of Formula I: 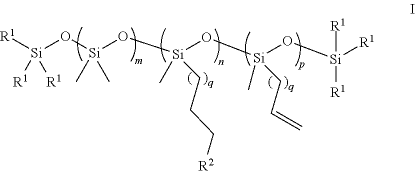
where m is from 5 to 150; n is from 1 to 3; p is from 0 to 3; q is from 0 to 8; each R¹ is independently C₁-C₆-alkyl, vinyl, phenyl, or benzyl; each R¹′ is independently C₁-C₆-alkyl;
R² is: 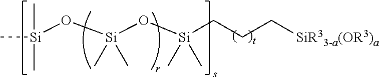
where r is from 0 to 5; s is 0 or 1; t is from 0 to 15; each R³ is independently C₁-C₆-alkyl; a is an integer of 1 to 3; wherein the polyorganosiloxane has degree of polymerization in the range of from 40 to 800.

2. The composition of claim 1 wherein, based on the weight of the composition, the concentration of the polyorganosiloxane is in the range of from 1.9 to 15 wt. %, the concentration of the filler particles is in the range of from 70 to 98 wt. %, and the concentration of the filler treating agent of Formula I is in the range of from 0.1 to 3 wt %; wherein the filler particles are aluminum, alumina, aluminum trihydrate, boron nitride, or zinc oxide particles.

3. The composition of claim 2 wherein each R¹ is independently C₁-C₆-alkyl; p is from 0 to 2; q is from 2 to 4; each R¹ is independently C₁-C₆-alkyl; and a is 2 or 3; wherein the filler particles are alumina particles at a concentration in the range of from 85 to 94 wt %, based on the weight of the composition.

4. The composition of claim 3 wherein each R¹ is independently methyl or ethyl; and p is 0 or 1.

5. The composition of claim 4 wherein each R¹ is methyl; m is from 50 to 125; n is from 1.8 to 2.2; each R³ is methyl; and p is from 0 to 0.5; wherein the alumina filler particles are present as a bimodal distribution of first alumina filler particles and second alumina filler particles.

6. The composition of claim 1 where n is 2 and R² is represented by: 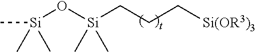
where t is 0 or 1 or 2 or 3; and p is 0.

7. The composition of claim 6 wherein t is 0; and each R³ is methyl.

8. The composition of claim 1 where n is 2 and R² is represented by: 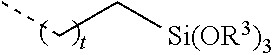
where q+t is in the range of 0 to 20; and p is 0.

9. The composition of claim 8 where q+t is in the range of from 3 to 14.

10. The composition of claim 8 where q+t is in the range of from 5 to 9.
